(19) United States
(12) Patent Application Publication
(10) Pub. No.: US 2008/0229218 A1
(43) Pub. Date: Sep. 18, 2008

(54) SYSTEMS AND METHODS FOR PROVIDING ADDITIONAL INFORMATION FOR OBJECTS IN ELECTRONIC DOCUMENTS

(75) Inventor: Aaron K. Maeng, Boston, MA (US)

Correspondence Address: Ruttler Law PLLC;One Union Square, 600 University Street, Suite 1919, Seattle, WA, 98101, US

(73) Assignee: Joon Maeng, Newcastle, WA (US)

(21) Appl. No.: 12/047,952

(22) Filed: Mar. 13, 2008

Related U.S. Application Data
(60) Provisional application No. 60/918,251, filed on Mar. 14, 2007.

(51) Int. Cl. G06F 3/048

(52) U.S. Cl. 715/760; 715/808

(57) ABSTRACT

This invention relates generally to software, and more specifically, to systems and methods for providing additional information for objects in electronic documents. In one embodiment, the invention includes a method for providing additional information for objects in a document including the steps of presenting an active object in a document, the active object being activatable upon selection; on activation of the active object, presenting a balloon having any combination of a selector and an operator, the selector and the operator being selectable, the operator being associated with an operation; when the balloon has a selector, on selection of the selector, presenting a second balloon having any combination of an additional selector and operator; and when the balloon has an operator, on selection of the operator, performing the operation associated with the operator with respect to the active object in the document. In one particular embodiment, the document is a web page.

### PRIORITY CLAIM

This application claims the benefit of U.S. Provisional Application No. 60/918,251 filed Mar. 14, 2007. The foregoing application is incorporated by reference in its entirety as if fully set forth herein.

### FIELD OF THE INVENTION

This invention relates generally to software, and more specifically, to systems and methods for providing additional information for objects in electronic documents.

### BACKGROUND

Website readers often desire additional information that relates to objects present within a web page displayed on a website. Currently, that additional information is accessed through hyperlinks, which are references or navigational elements present within the web page to different sections within the web page or entirely new web pages that contain the desired information. Activation of a hyperlink within the web page results in an associated web page section or new web page being retrieved and displayed for review by the reader. The newly displayed web page often replaces the original document and the reader returns to the original web page using a back button. This methodology suffers in that it is inconvenient for a reader to leave a web page in order to get additional information. First, it is taxing on the reader's intellect to constantly keep track of their navigational position within a series of web pages. Further, a reader wastes significant amounts of time by accessing and reviewing web pages that turn out to be irrelevant.

Accordingly, there has been some movement towards using balloon windows, also known as pop-up windows, to provide information for web page objects without replacing the web page. For instance, online text editors highlight misspelled words and provide correctly spelled options in balloon windows for selection. Also, online advertisers use balloon windows to present further product descriptions for advertisements. Further, dictionary definitions of words are sometimes provided through a balloon window. However, use of balloon windows and the information presented therein has been limited. Accordingly, while desirable results have been achieved, there exists much room for improvement. What is needed then are systems and methods for providing additional information for objects in electronic documents.

### SUMMARY

This invention relates generally to software, and more specifically, to systems and methods for providing additional information for objects in electronic documents. In one embodiment, the invention includes a method for providing additional information for objects in a document including the steps of presenting an active object in a document, the active object being activatable upon selection; on activation of the active object, presenting a balloon having any combination of a selector and an operator, the selector and the operator being selectable, the operator being associated with an operation; when the balloon has a selector, on selection of the selector, presenting a second balloon having any combination of an additional selector and operator; and when the balloon has an operator, on selection of the operator, performing the operation associated with the operator with respect to the active object in the document. In one particular embodiment, the document is a web page.

### BRIEF DESCRIPTION OF THE DRAWINGS

Embodiments of the present invention are described in detail below with reference to the following drawings:

FIG. 1 is a screen shot of a PRIOR ART reference presenting information for an object in a document;

FIG. 2 is a screen shot illustrating additional information being presented for an object in a document, in accordance with an embodiment of the invention;

FIG. 3 is a screen shot illustrating advertisements being presented for an object in a document, in accordance with an embodiment of the invention;

FIG. 4 is a screen shot illustrating additional information being presented for a visitor defined object in a document, in accordance with an embodiment of the invention;

FIG. 5 is a block diagram of a system for additional information being presented for an object in a document, in accordance with an embodiment of the invention;

FIG. 6 is a screen shot illustrating configuration of presenting additional information for an object in a document, in accordance with an embodiment of the invention;

FIG. 7 is block diagram illustrating interactions between a web browser and a web server for additional information being presented for an object in a document, in accordance with an embodiment of the invention;

FIG. 8 is a block diagram illustrating interactions between a web browser and a website for additional information being presented for an object in a document, in accordance with an embodiment of the invention; and

FIG. 9 is a block diagram illustrating interactions between application software and other entities for additional information being presented for an object in a document, in accordance with an embodiment of the invention.

### DETAILED DESCRIPTION

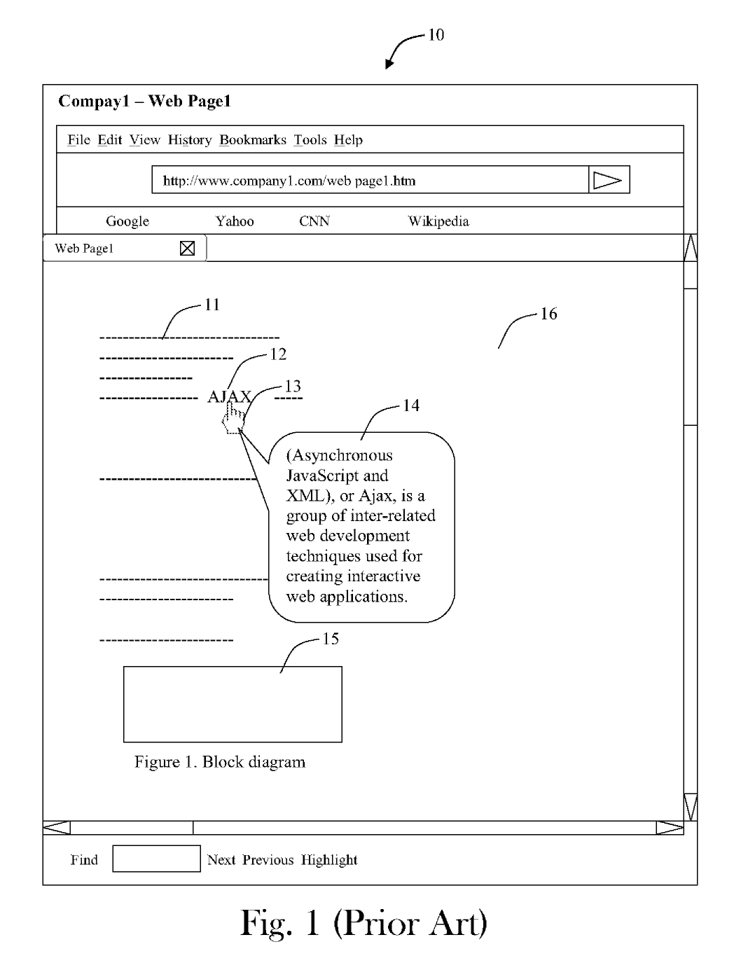

This invention relates generally to software, and more specifically, to systems and methods for providing additional information for objects in electronic documents. Specific details of certain embodiments of the invention are set forth in the following description and in FIGS. 1-9 to provide a thorough understanding of such embodiments. The present invention may have additional embodiments, may be practiced without one or more of the details described for any particular described embodiment, or may have any detail described for one particular embodiment practiced with any other detail described for another embodiment.

DEFINITIONS. A document means any electronic representation of information, including through web pages, MS WORD, EXCEL, POWERPOINT documents, text editors, ADOBE documents, and any other similar electronic representation of information. A visitor is an individual that accesses a document whereas a reader is an individual that accesses a web page. A document includes a plurality of objects such as words, sentences, tables, figures, areas, numbers, advertisements, images, video clips, buttons, icons, background color, hyperlinks, icons, and buttons. Objects may be either active or passive objects. An active object is an object that provides additional information when activated. Oppositely, a passive object does not provide additional information when activated. Active objects are either defined by a document provider or chosen by a document visitor or web page reader. A balloon is a means for presenting the additional information and may include a pop-up window, a docked window, an embedded window, an audio announcement, or any other means for providing information. A document presents active objects in a manner that distinguishes them with passive objects, such as by using different colors, fonts, shapes, styles, or responses to visitor input. Activation of an active object to request additional information occurs by selecting the object, such as by moving a cursor over the object, clicking on the object, or performing another similar action with respect to the object. Alternatively, activation of an active object occurs by selecting the object using voice activation, optical tracking, laser pointer, or some other similar technology. A website includes a collection of documents under a single domain name that are accessible over a local or wide area network. Visiting a website means using a browser application to access a document available on the website.

A computer system or any electronic device that performs similar functions is employable to perform any embodiment discussed herein. Examples of such devices are personal computers, notebook computers, servers, hand held devices, wireless phones, PDAs, gaming devices, television devices, and media players.

Any operating system or application software is employable to perform any embodiment discussed herein. Examples of operating systems and application software include MICROSOFT operating systems, APPLE operating systems, IBM operating systems, UNIX operating systems, and any application software produced by MICROSOFT, APPLE, IBM, ADOBE, ORACLE, SAP or other company such as MS WORD, MS EXCEL, MS POWERPOINT, INTERNET EXPLORER, FIREFOX BROWSER, and ADOBE ACROBAT.

FIG. 1 is a screen shot of a prior art reference presenting information for an object in a document. In one embodiment, the prior art reference includes a web browser 10, a first window 16, text 11, object 12, cursor 13, balloon 14, and FIG. 15. The web browser 10 includes a number of menu items for performing various functions, including entering a website address, retrieving book-marked websites, and receiving search parameters, and the first window 16 for displaying a document therein. The document contains the text 11, object 12, and the FIG. 15, wherein the text 11 and the FIG. 15 are passive objects and the object 12 is an active object. The cursor 13 is movable over the document and is usable to activate the object 12 by selecting the object 12. When the object 12 is activated, the balloon 14 appears and provides the definition of the object 12, in this case the definition of the term AJAX. The definition of the object 12 is static text.

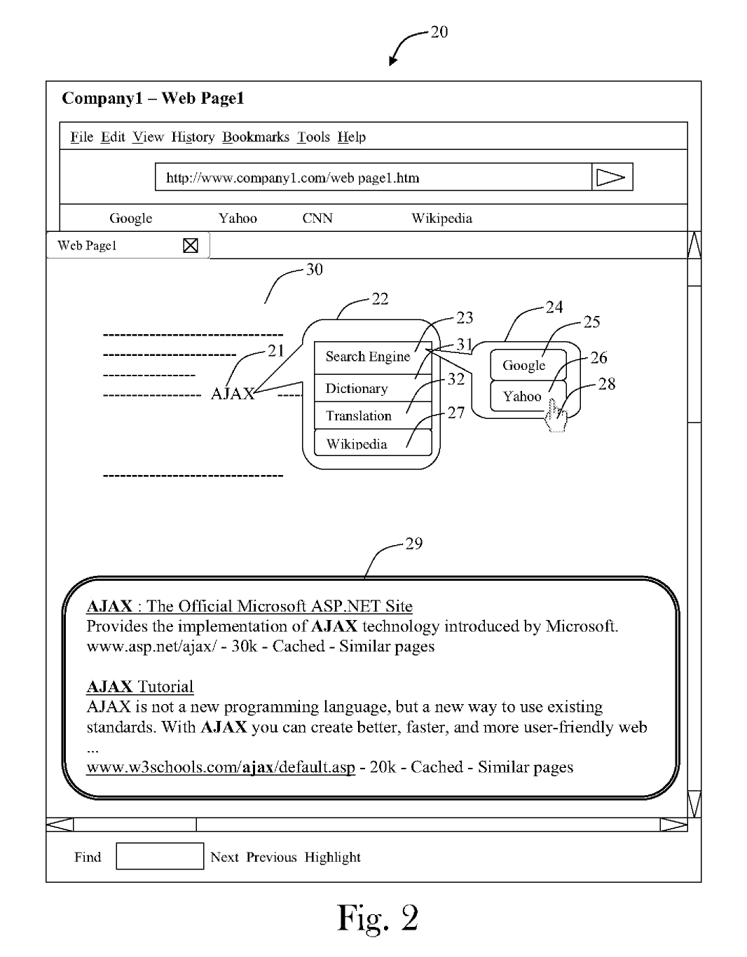

FIG. 2 is a screen shot illustrating additional information being presented for an object in a document, in accordance with an embodiment of the invention. In one embodiment, the screen shot includes a web browser 20, a first window 30, an active object 21, a first balloon 22, a search engine selector 23, a dictionary selector 31, a translation selector 32, a WIKIPEDIA operator 27, a second balloon 24, a GOOGLE operator 25, a YAHOO operator 26, a cursor 28, and a second window 29. The active object 21 is displayed within the first window 30 and the second window 29 is embedded within the first window 30. The first balloon 22 and the second balloon 24 are initially not visible. When the active object 21 is activated by selection, such as by moving the cursor 28 over or clicking on the active object 21, the first balloon 22 is presented having selectors and operators contained therein. The first balloon 22 can have any combination of selectors and operators, which means only one selector, only one operator, both a selector and an operator, or a plurality of only selectors, only operators, or both selectors and operators. As will become more apparent, selectors differ from operators in that selection of selectors results in an additional balloon being presented while selection of operators results in an operation being taken with regards to the underlying active object, in this case the active object 21. The selectors and operators within the first balloon 22 include the search engine selector 23, the dictionary selector 31, the translation selector 32, and the WIKIPEDIA operator 27. Selection of the search engine selector 23, such as by moving the cursor 28 over or clicking on the search engine selector 23, results in the second balloon 24 being presented. The second balloon 24 includes operators related to the search engine selector 23 such as the GOOGLE operator 25 and the YAHOO operator 26. Selection of the YAHOO operator 26, such as by moving the cursor 28 over or clicking on the YAHOO operator 26, results in the second window 29 displaying search results for the active object 21 as provided by the YAHOO search engine. Similarly, selection of the GOOGLE operator 25 results in the second window 29 displaying search results for the active object 21 as provided by the GOOGLE search engine. The search results may include hyperlinks therein and selection of the hyperlinks results in presentation of linked documents within the second window 29, a balloon, or a separate window or web browser.

Returning to the first balloon 22, selection of the WIKIPEDIA operator 27, such as by moving the cursor 28 over or clicking on the WIKIPEDIA operator 27, results in a balloon or the second window 29 displaying encyclopedia results for the active object 21 as provided by the WIKEPEDIA website. Additionally, selection of the dictionary operator 31 results in a balloon window or the second window 29 displaying the dictionary definition of the active object 21. Lastly, selection of the translation selector 32 results in a balloon window providing various language operators such as French, Spanish, and German. Selection of the language operators results in a balloon or the second window 29 displaying a foreign language translation of the active object 21. Many other selectors and operators are possible including video selectors, news selectors, people search selectors, map selectors, image selectors, and any others relating to commercial, political, or educational subjects. In one particular embodiment, active objects indicate activation such as by changing color. In another embodiment, the objects, balloons, selectors, operators, and windows are differently shaped, arranged, or presented.

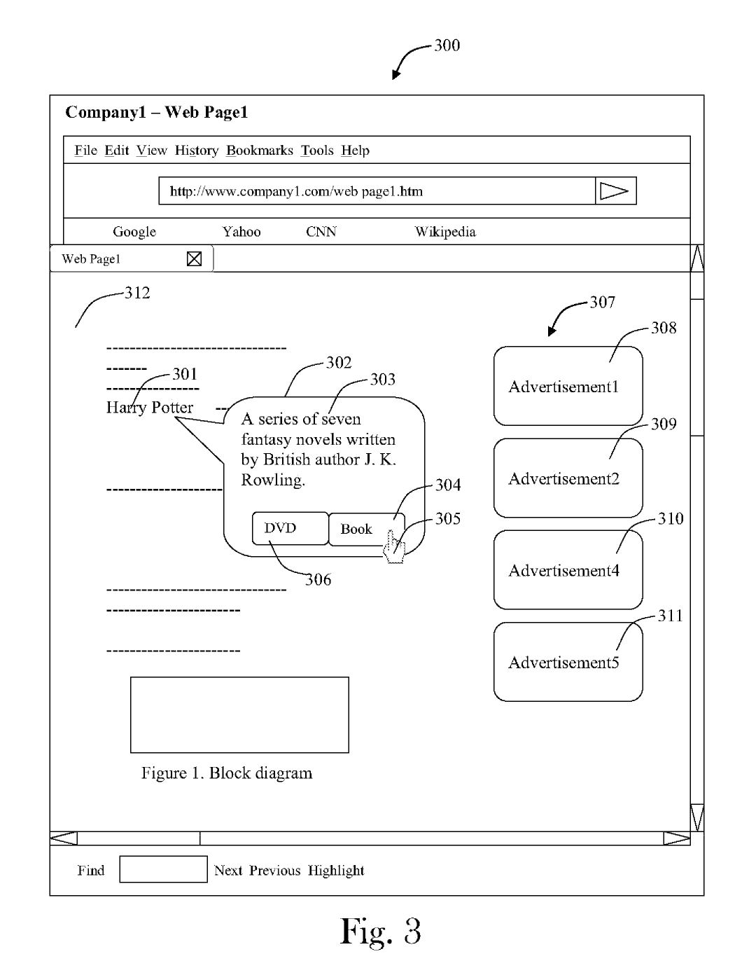

FIG. 3 is a screen shot illustrating advertisements being presented for an object in a document, in accordance with an embodiment of the invention. In one embodiment, the screen shot includes a web browser 300, a first window 312, a cursor 305, an active object 301, a balloon 302, an active object description 303, a DVD operator 306, a book operator 304, and advertisements 307, which include advertisement 308, 309, 310, and 311. The active object 301 and the advertisements 307 are displayed within the first window 312. The balloon 302 is initially not visible. When the active object 301 is activated by selection, such as by moving the cursor 305 over or clicking on the active object 301, the balloon 302 is presented having the active object description 303, the DVD operator 306, and the book operator 304 contained therein. The active object description 303 provides a brief description of the active object 301, in this instance a description of the HARRY POTTER series. Selection of the DVD operator 306, such as by moving the cursor 305 over or clicking on the DVD operator 306, results in one or more of the advertisements 307 being changed to an advertisement for a DVD that relates to the active object 301, in this case a HARRY POTTER DVD. Similarly, selection of the book operator 304 results in one or more of the advertisements 307 being changed to an advertisement for a book that relates to the active object 301, in this case a HARRY POTTER book. The advertisements may include hyperlinks therein and selection of the hyperlinks results in presentation of linked documents within a balloon, a second window, or a separate web browser. In one particular embodiment, the balloon for an advertisement active object presents additional selectors or operators, such as ‘Visit Site’, ‘Find Bargains’, and ‘Bookmark’.

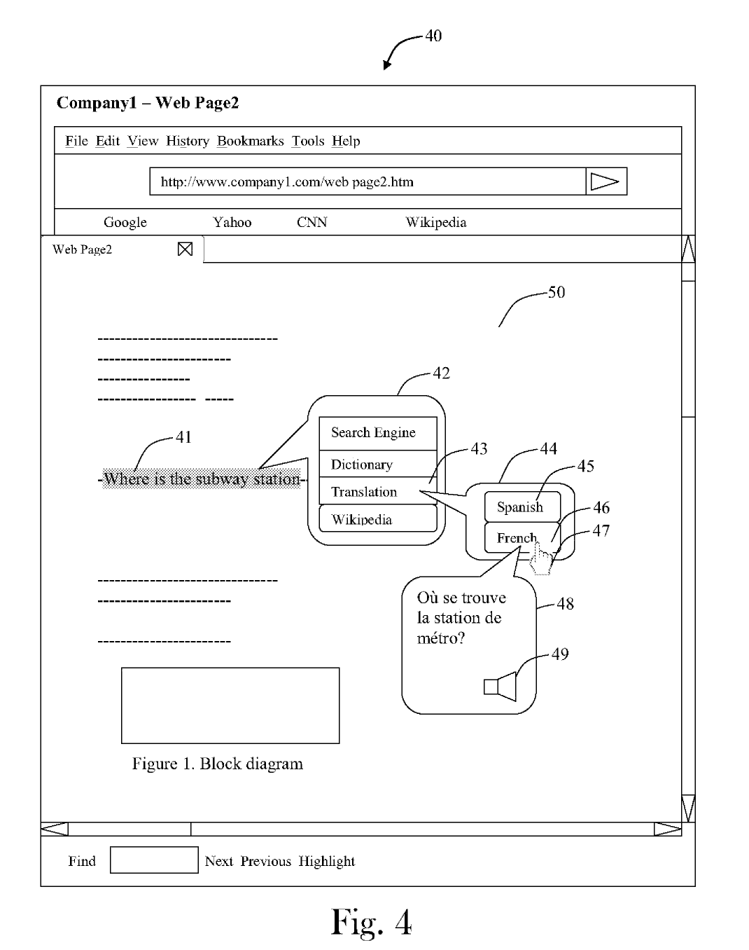

FIG. 4 is a screen shot illustrating additional information being presented for a visitor defined object in a document, in accordance with an embodiment of the invention. In one embodiment, the screen shot includes a web browser 40, a first window 50, a cursor 47, text 41, a first balloon 42, a translation selector 43, a second balloon 44, a Spanish operator 45, a French operator 46, a third balloon 48, and a sound operator 49. The text 41 is displayed in the first window 50 and the first balloon 42, the second balloon 44, and the third balloon 48 are not initially visible. Although the text 41 is initially static text and a passive object, the text 41 becomes an active object when chosen by a website reader, such as by being highlighted using the cursor 47. Upon being chosen, when the text 41 is activated by being selected, such as by moving the cursor 47 over or clicking on the text 41, the balloon 42 is presented having selectors and operators contained therein. When the translation selector 43 is selected, the second balloon 44 is presented having the Spanish operator 45 and the French operator 46 contained therein. When the French operator 46 is selected the third balloon 48 is presented having a French translation of the text 41, in this case a French translation of ‘Where is the subway station.’ In one particular embodiment, the third balloon 48 further includes the sound operator 49. Selection of the sound operator 49 results in an audible rendition of the French translation of the text 41. When the text 41 is un-chosen, the first balloon 42, the second balloon 44, and the third balloon 48 are collapsed and the text 41 returns to being static text and a passive object. Accordingly, active objects can be either pre-defined by a document provider or chosen by a document visitor or website reader. Further, a given document can have pre-defined active objects and also provide for active objects being chosen by document visitors and website readers.

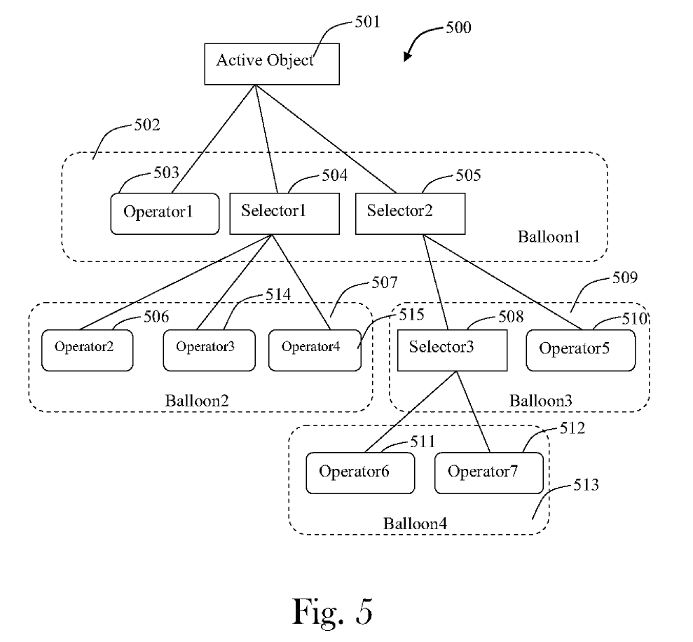

FIG. 5 is a block diagram of a system for additional information being presented for an object in a document, in accordance with an embodiment of the invention. In one embodiment, the system 500 includes active object 501, balloon 502, operator 503, selector 504, selector 505, balloon 507, operator 506, operator 514, operator 515, balloon 509, selector 508, operator 510, balloon 513, operator 511, and operator 512. System 500 may be implemented within any document and the active object 501 can be either pre-defined by a document provider or chosen by a document visitor. When the active object 501 is activated by being selected, the balloon 502 is presented having the operator 503, the selector 504, and the selector 505 contained therein. As referenced above, selectors differ from operators in that selection of selectors results in an additional balloon being presented while selection of operators results in an operation being taken with regards to the underlying active object, in this case the active object 501. Accordingly, selection of the operator 503 results in an operation being taken with regards to the active object 501 whereas selection of the selector 504 results in the balloon 507 being presented containing the operator 506, the operator 514, and the operator 515 therein. Likewise, selection of the selector 505 results in the balloon 509 being presented containing the selector 508 and the operator 510 contained therein. Similarly, selection of the selector 508 results in the balloon 513 being presented containing the operator 511 and the operator 512 therein. Thus, selection of selectors result in additional options whereas selection of operators result in an operation being taken with regard to the underlying active object, in this case the active object 501. Any combination of balloons, selectors, and operators is possible and balloons can include additional items in addition to selectors and operators, such as static text, graphics, and hyperlinks.

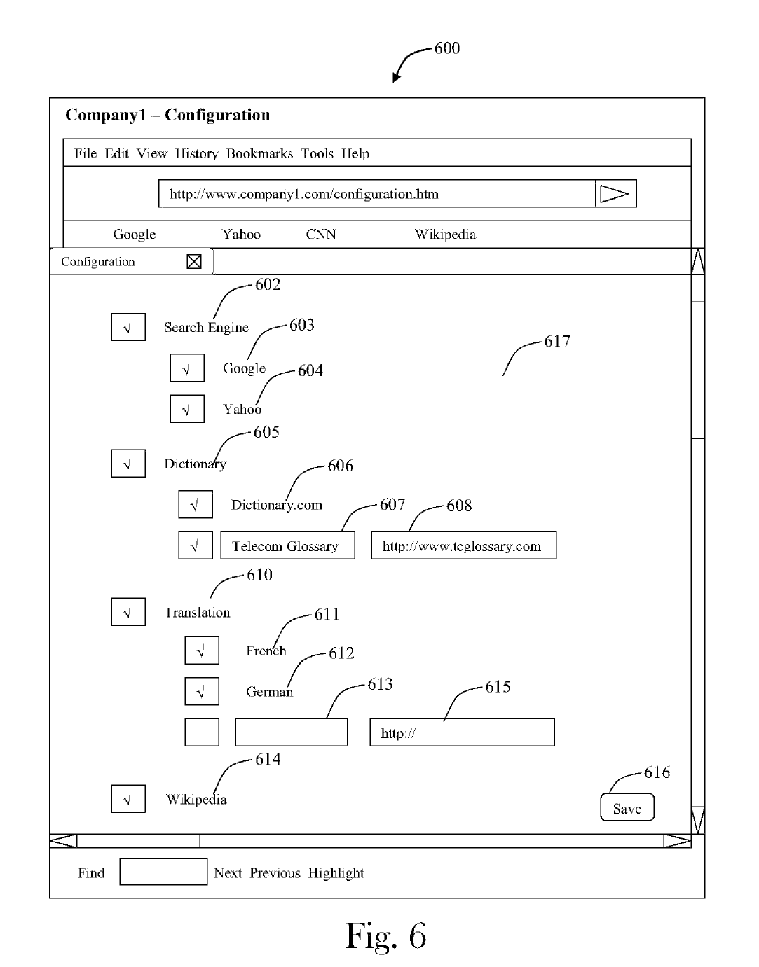

FIG. 6 is a screen shot illustrating configuration of presenting additional information for an object in a document, in accordance with an embodiment of the invention. In one embodiment, the screen shot includes a web browser 600, a first window 617, search engine selector 602, GOOGLE operator 603, YAHOO operator 604, dictionary selector 605, DICTIONARY.COM operator 606, custom operator 607, input box 608, translation selector 610, French operator 611, German operator 612, custom operator 613, input box 615, WIKIPEDIA operator 614, and save button 616. The web browser 600 includes the first window 617, which presents the selectors, operators, input boxes, and save button therein. Configuration of the selectors and operators within the window 617 provides for customization of balloons that are presented upon activation of an active object as described in other embodiments herein. Accordingly, when the search engine selector 602, the dictionary selector 605, the translation selector 610, and the WIKIPEDIA operator are enabled, these selectors and operators appear in a balloon upon activation of an active object within a document. Similarly, when both the GOOGLE operator 603 and the YAHOO operator 604 are enabled, these operators appear in a balloon upon selection of the search engine selector 602. Likewise, when the DICTIONARY.COM operator 606 is enabled, this operator appears in a balloon upon selection of the dictionary selector 605. Lastly, when both the French operator 611 and the German operator 612 are enabled, these operators appear in a balloon upon selection of the translation selector 610. Any of the selectors or operators can remain non-enabled and therefore not appear in any balloons upon activation of the active object. In one particular embodiment, if only one operator is enabled under a selector, the operator is presented without presenting the selector. For example, if the search engine selector 602 is enabled and only the GOOGLE operator 603 is enabled, the GOOGLE operator 603 is presented in the balloon along with the dictionary selector 605, the translation selector 610, and the WIKIPEDIA operator 614, assuming these are also enabled.

Operators are associated with sources for performing requested operations. For instance, the GOOGLE operator 603 is associated with the GOOGLE search engine. Similarly, the YAHOO operator 604 is associated with the YAHOO search engine. Accordingly, when the GOOGLE operator 603 is selected with respect to an active object, the GOOGLE search engine is queried using the active object. In one particular embodiment, an operator and its source are visitor configurable. For instance, any operator label can be entered for the custom operator 607 and its associated source can be entered for the input box 608. For example, TELECOM GLOSSARY can be entered for the custom operator 607 and its URL www.tcglossary.com, the source of TELECOM GLOSSARY, can be entered for the input box 608. Upon selection of the dictionary selector 605, TELECOM GLOSSARY would appear as an operator and selection would result in glossary results for the active object. Similarly, any label can be entered for the custom operator 613 and its associated source can be entered for the input box 615. For instance, Spanish can be entered for the custom operator 613 and a URL for translating a text in Spanish can be entered into the input box 608. Upon selection of the translation selector 610, Spanish would appear as an operator and selection would result in a Spanish translation of the active object. In other embodiment, selectors are configurable as well whereby a selector name can be configured along with related operators and associated sources. For example, a product review selector can be configured along with operators and sources for providing product reviews. The save button 616 saves the configuration and the configuration is changeable at any time. The saved selectors and operators are then presented upon activation of an active object as described supra.

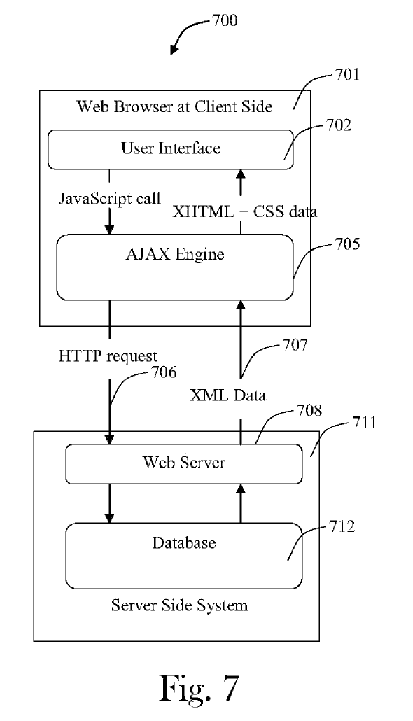

FIG. 7 is block diagram illustrating interactions between a web browser and a web server for additional information being presented for an object in a document, in accordance with an embodiment of the invention. In one embodiment, interactions 700 include a web browser 701, a user interface 702, an AJAX (Asynchronous JavaScript and XML) engine 705, a server 711, a web server 708, and a database 712. The web browser 701 is a software application at a client side that enables a website reader to view and interact with information presented in a web page from a website hosted on the server 711. The web browser 701 includes the user interface 702 and the AJAX engine 705. The server 711 includes the web server 708, and the database 712. Traditional interactions between a web browser and a server do not include an AJAX engine and HTTP requests are sent from a web browser to a web server. The web server responds with HTML data for presentation on the requesting web browser. Subsequent requests are required by the web browser to the web server in order to update data for presentation on the requesting web browser. The interactions 700 differ from traditional interactions in that within the web browser 701, the user interface 702 makes script calls to the AJAX engine 705. The AJAX engine 705 can respond directly to the script calls or send the HTTP request 706 to the web server 708 on the server 711. The web server 708 can then respond to the HTTP request 706 with a response 707 to the AJAX engine 705, which can then respond to the user interface 702. Script calls to the AJAX engine may be initiated by event handlers such as the following:
a. onMouseOver: This event handler is triggered when a cursor is passed over an object.
b. onMouseOut: This event handler is triggered when a cursor is taken off of an object.
c. onClick: This event handler is triggered when an object is clicked.

Accordingly, when a cursor is passed over an object, the onMouseOver event handler is triggered. Subsequently, when the cursor is moved off of the object, the onMouseOut event handler is triggered. When an object is clicked, the onClick event handler is triggered.

The interactions 600 are usable in coordination with other embodiments disclosed herein. For instance, when the cursor 305 clicks the book operator 304 in FIG. 3, the onClick event handler is triggered and the AJAX engine 705 submits the HTTP request 706 to the web server 708 for new advertisements associated with the active object 301, in this case HARRY POTTER books. The web server 708 retrieves the new advertisements from the database 712 and responds to the AJAX engine 705 with the new advertisements through the response 707. In certain embodiments, the response 707 is in the form of Extensible Markup Language (XML). The AJAX engine 705 responds to the user interface 702 with the new advertisements and the web browser 701 replaces one or more of the advertisements 307 with the new advertisements. In one particular embodiment, the AJAX engine 705 responds to the user interface 702 using Extensible HyperText Markup Language (XHTML) and/or Cascading Style Sheets (CSS). CSS is a style sheet language used to describe the presentation of data in a markup language such as HTML and XHTML. Accordingly, using the interactions 600 the advertisements 307 are replaceable with new advertisements relating to the active object 301 without refreshing the entire document. In one particular embodiment, the web server 708 sends a query to other web sites to get information depending on the operation. For instance, the web server 708 can send a query to perform a search at GOOGLE's search engine if the operation requires a search and return search results to the web browser 701. The interaction between the web browser 701 and the server 711 may be entirely different and still be within the scope of the present invention. Accordingly, active objects may be activated and balloons having selectors and operators may be presented using any other technology or methodology.

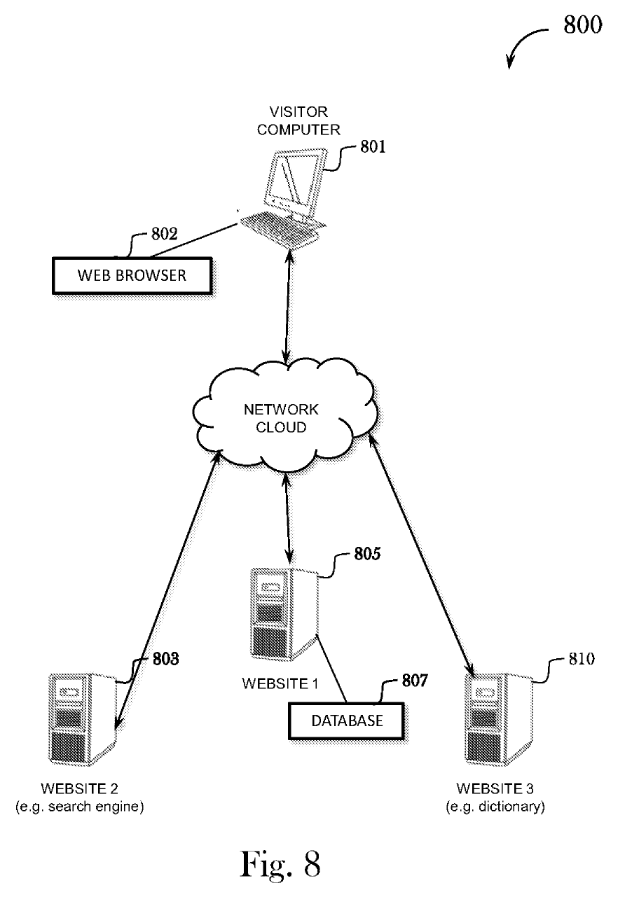

FIG. 8 is a block diagram illustrating interactions between a web browser and a website for additional information being presented for an object in a document, in accordance with an embodiment of the invention. In one embodiment, system 600 includes a computer, a web browser 802, a first website 805, a database 807, a second website 803, and a third website 810. The web browser 802 on the computer 801 is configurable to access a web page having active objects from the first website 805. As discussed in reference to other embodiments herein, when an active object on the document is activated upon being selected, a balloon is presented having operators and selectors therein. Upon selection of the operators or selectors, the first website 805 retrieves corresponding data, such as from the database 807 or from other websites such as the second website 803 and the third website 810. For instance, the second website 803 can be GOOGLE and can provide search results for a search operator on the first website 805. The third website 810 can be DICTIONARY.COM and can provide dictionary results for a dictionary operator on the first website 805. However, additional information for active objects, selectors, and operators may be retrieved or accessed using any other technology or methodology.

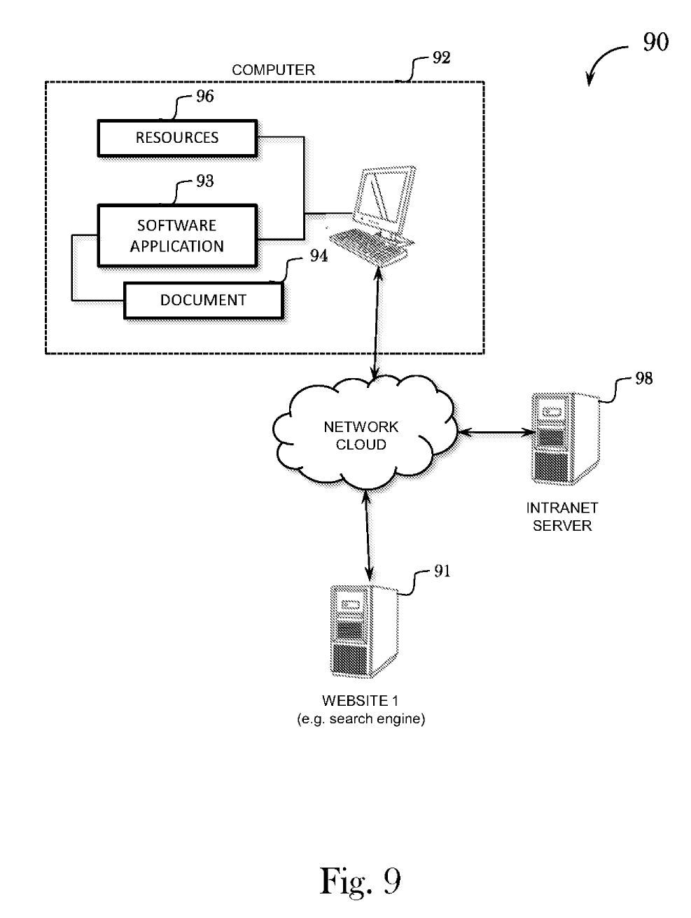

FIG. 9 is a block diagram illustrating interactions between application software and other entities for additional information being presented for an object in a document, in accordance with an embodiment of the invention. In one embodiment, system 90 includes a computer 92, application software 93, document 94, resources 96, an internet website 91, and an intranet server 98. The computer 92 includes the application software 93, which is configurable to present the document 94 having active objects therein. The application software 93 is any software application including a web browser, a text editor/viewer, or a graphics editor/viewer. As discussed in reference to other embodiments herein, when an active object on the document is activated upon being selected, a balloon is presented having operators and selectors therein. Upon selection of the operators or selectors, the application software 93 retrieves corresponding data, such as from the resources 96 or from other entities such as the intranet server 98 or the internet website 91. The resources 96 can include a database, another software application, a storage device, or an input device such as a speaker or microphone. However, active objects may be activated and balloons having selectors and operators may be presented using any other technology or methodology.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for providing additional information for objects in a document, the method comprising the steps of:
presenting an active object in a document, the active object being activatable upon selection;
on activation of the active object, presenting a balloon having any combination of a selector and an operator, the selector and the operator being selectable, the operator being associated with an operation;
when the balloon has a selector, on selection of the selector, presenting a second balloon having any combination of an additional selector and operator; and
when the balloon has an operator, on selection of the operator, performing the operation associated with the operator with respect to the active object in the document.

2. The method of claim 1 wherein the document is a web page.

3. The method of claim 1, wherein the active object is defined by a document provider.

4. The method of claim 1, wherein the active object is chosen by a document visitor.

5. The method of claim 1, wherein the operation comprises translating the active object into a foreign language.

6. The method of claim 1, wherein the operation comprises presenting at least one advertisement relating to the active object.

7. The method of claim 1, wherein the at least one of the selector and the operator presented with the balloon are configured by a document provider.

8. The method of claim 1, wherein the at least one of the selector and the operator presented with the balloon are configured by a document visitor.

9. A computer system programmed to perform the method of claim 1.

10. A wireless mobile device programmed to perform the method of claim 1.

11. A computer program embodied in a computer-readable medium and executable by a computer processor for providing additional information for objects in a document, the computer program comprising instructions for:
presenting an active object in a document, the active object being activatable upon selection;
on activation of the active object, presenting a balloon having any combination of a selector and an operator, the selector and the operator being selectable, the operator being associated with an operation;
when the balloon has a selector, on selection of the selector, presenting a second balloon having any combination of an additional selector and operator; and
when the balloon has an operator, on selection of the operator, performing the operation associated with the operator with respect to the active object in the document.

12. The computer program of claim 11 wherein the document is a web page.

13. The computer program of claim 11, wherein the active object is defined by a document provider.

14. The computer program of claim 11, wherein the active object is chosen by a document visitor.

15. The computer program of claim 11, wherein the operation comprises translating the active object into a foreign language.

16. The computer program of claim 11, wherein the operation comprises presenting at least one advertisement relating to the active object.

17. The computer program of claim 11, wherein the at least one of the selector and the operator presented with the balloon are configured by a document provider.

18. The computer program of claim 11, wherein the at least one of the selector and the operator presented with the balloon are configured by a document visitor.

19. A web server programmed with the computer program of claim 11.

20. A web browser programmed with the computer program of claim 11.
